(19) United States
(12) Patent Application Publication
(10) Pub. No.: US 2023/0385936 A1
(43) Pub. Date: Nov. 30, 2023

(54) INFORMATION PROCESSING DEVICE, INFORMATION PROCESSING METHOD, AND PROGRAM

(71) Applicant: SONY GROUP CORPORATION, TOKYO (JP)

(72) Inventors: TAKAO TAJIRI, TOKYO (JP); TAKASHI YAMASHITA, KANAGAWA (JP)

(21) Appl. No.: 18/245,979

(22) PCT Filed: Aug. 13, 2021
(86) PCT No.: PCT/JP2021/029786

§ 371 Date: Mar. 20, 2023

(30) Foreign Application Priority Data
Sep. 28, 2020 (JP) 2020-161596

(51) Int. Cl. G06Q 40/06; G06N 5/022

(52) U.S. Cl. CPC G06Q 40/06; G06N 5/022

(57) ABSTRACT

An action that is possible to be executed by a subject in a predetermined situation is predicted with high accuracy. There is provided an information processing device including a prediction unit that outputs preference prediction data indicating prediction of a preference action that is possible to be executed by a subject in a predetermined situation on the basis of preference record data indicating a record of the preference action related to a predetermined task executed by the subject, in which the prediction unit inputs the preference record data to a classifier generated by manifold learning, and outputs the preference prediction data on the basis of applying a prediction model based on assumed information related to the predetermined situation for each of a plurality of classified units.

### TECHNICAL FIELD

The present disclosure relates to an information processing device, an information processing method, and a program.

### BACKGROUND ART

It is quite important to appropriately analyze actions of task executors who execute certain tasks. For this reason, in recent years, many systems for automating or assisting the analysis as described above have been proposed. For example, Patent Document 1 proposes a system for analyzing an investment action by an investment fund (hereinafter simply referred to as a fund) and performing rating based on a result of the analysis.

### CITATION LIST

### Patent Document

Patent Document 1: Japanese Patent Application Laid-Open No. 2009-245368

### SUMMARY OF THE INVENTION

### Problems to be Solved by the Invention

However, the rating method disclosed in Patent Document 1 is for past records, and is not sufficient for verifying the usefulness of a future fund.

### Solutions to Problems

According to an aspect of the present disclosure, there is provided an information processing device including a prediction unit that outputs preference prediction data indicating prediction of a preference action that is possible to be executed by a subject in a predetermined situation on the basis of preference record data indicating a record of the preference action related to a predetermined task executed by the subject, in which the prediction unit inputs the preference record data to a classifier generated by manifold learning, and outputs the preference prediction data on the basis of applying a prediction model based on assumed information related to the predetermined situation for each of a plurality of units classified.

Furthermore, according to another aspect of the present disclosure, there is provided an information processing method, including outputting, by a processor, preference prediction data indicating prediction of a preference action that is possible to be executed by a subject in a predetermined situation on the basis of preference record data indicating a record of the preference action related to a predetermined task executed by the subject, in which the outputting includes inputting the preference record data to a classifier generated by manifold learning, and outputting the preference prediction data on the basis of applying a prediction model based on assumed information related to the predetermined situation for each of a plurality of classified units.

Furthermore, according to another aspect of the present disclosure, there is provided a program for causing a computer to function as an information processing device, in which the information processing device includes a prediction unit that outputs preference prediction data indicating prediction of a preference action that is possible to be executed by a subject in a predetermined situation on the basis of preference record data indicating a record of the preference action related to a predetermined task executed by the subject, and the prediction unit inputs the preference record data to a classifier generated by manifold learning, and outputs the preference prediction data on the basis of applying a prediction model based on assumed information related to the predetermined situation for each of a plurality of units classified.

### BRIEF DESCRIPTION OF DRAWINGS

FIG. 1 is a block diagram illustrating a functional configuration example of a learning device 10 according to one embodiment of the present disclosure.

FIG. 2 is a block diagram illustrating a functional configuration example of a prediction device 20 according to the same embodiment.

FIG. 3 is a diagram for describing classification of a preference target using a self-organizing map by a prediction unit 210 according to the same embodiment and generation of a map in which intensity of an index based on a preference ratio of a classified preference target is expressed in a form of a heat map.

FIG. 4 is a schematic diagram for describing output of preference prediction data by the prediction unit 210 according to the same embodiment.

FIG. 5 is a diagram illustrating an example of a map in which intensity of a predicted preference ratio of a preference target is expressed in the form of a heat map, the map being generated by the prediction unit 210 according to the same embodiment.

FIG. 6 is an example of a map generated by the prediction unit 210 according to the same embodiment, in which intensity of a difference between prediction information of an active weight in a predetermined situation and record information of an active weight in the past is expressed in the form of a heat map in each of BMUs.

FIG. 7 is a diagram illustrating an example of a map based on preference prediction data indicating prediction of a preference action that is possible to be executed by a plurality of subjects according to the same embodiment.

FIG. 8 is a flowchart illustrating an example of a flow of prediction of a preference action by the prediction unit 210 according to the same embodiment.

FIG. 9 is a block diagram illustrating a hardware configuration example of an information processing device 90 according to the same embodiment.

### MODE FOR CARRYING OUT THE INVENTION

Hereinafter, preferred embodiments of the present disclosure will be described in detail with reference to the accompanying drawings. Note that in the description and the drawings, components having substantially the same functional configuration are denoted by the same reference numerals, and redundant descriptions are omitted.

Note that the description will be made in the following order.

1. Embodiments

1.1. Overview

1.2. System configuration example

1.3. Details of prediction

1.4. Flow of prediction

2. Hardware configuration example

3. Summary

### 1. Embodiment

<<1.1. Overview>>

For example, it is assumed that a certain organization selects a task executor to whom the operation is newly entrusted. In this case, it is important to accurately predict what action a certain task executor will take with respect to various situations that may occur in the future.

Furthermore, in a case where an action that is possible to be executed by a task executor can be predicted with high accuracy, it is theoretically possible to obtain an equivalent profit by causing another person or system to substitute for the predicted action without newly employing a task executor.

However, the prediction of the action that is possible to be executed by the task executor as described above becomes more difficult as the task becomes more complicated.

As an example, it is assumed that the task is asset management and the task executor is a fund that performs an investment action for a financial product.

Generally, it is considered that an investment action by a fund requires a high degree of expertise and is performed based on complicated decision making.

For this reason, it is considered that it is difficult to accurately predict the investment action by the fund and reproduce (imitate) the prediction result.

A technical idea according to one embodiment of the present disclosure has been conceived by focusing on the points described above, and makes it possible to accurately predict an action that is possible to be executed by a task executor (subject) in a predetermined situation.

For this reason, one of features of an information processing method according to the present embodiment is to convert an action form that seems to be complicated into a response function using a property that a manifold analyzes an observation target in a locally linearizable region.

That is, in the information processing method according to the present embodiment, an action manner considered to be complicated is divided into scales that can be modeled, and response functionalization is performed for each scale.

For this purpose, a prediction device 20 that executes the information processing method according to the present embodiment includes a prediction unit 210 that outputs preference prediction data indicating prediction of a preference action that is possible to be executed by a subject in the predetermined situation on the basis of preference record data indicating a record of the preference action related to a predetermined task executed by the subject.

Furthermore, one of the features of the prediction unit 210 according to the present embodiment is to input the preference record data to a classifier generated by manifold learning, and to output the preference prediction data on the basis of applying a prediction model based on assumed information related to a predetermined situation for each of a plurality of classified units.

Note that, in the following, a case where the predetermined task described above is asset management and the preference action is an investment action for a financial product will be described as a main example.

In this case, the preference record data described above may include record information of an active weight based on an investment action executed by the subject in the past. Furthermore, the preference prediction data described above may include prediction information of an active weight based on an investment action that is possible to be executed in a predetermined situation.

That is, the prediction device 20 according to the present embodiment may predict an active weight determined by an investment action that is possible to be executed in a certain situation by a fund selected as a subject on the basis of an active weight determined by an investment action performed in the past by the fund.

Note that, for example, in a case where a profit (fund return) in a case where a certain fund is employed is to be predicted, a method of first predicting a factor return, and then predicting the fund return on the basis of the predicted factor return is also assumed.

However, information like the factor return is greatly affected by uncontrollable market variations and varies independently of decision-making by the fund.

That is, since information like the factor return largely depends on external information whose occurrence time is random and whose intensity is unpredictable, it can be said that the prediction of the fund return based on the prediction of the factor return is highly random and unreliable.

On the other hand, the active weight is a result of the investment action by the fund, and does not vary regardless of the decision-making of the fund.

Note that the active weight is also affected by the external information whose occurrence time is random and whose intensity is unpredictable. However, since the fund does not respond sensitively to all the external information, and it is also assumed that the fund makes a long-term investment, it can be said that the influence of the external information is smaller than that of the factor return or the like.

Therefore, as in the information processing method according to the present embodiment, in a case where the active weight is predicted as a result of the investment action possible to be executed by the fund in the future, highly accurate prediction closely related to the decision-making of the fund can be achieved.

Note that the information processing method according to the present embodiment is assumed to be particularly effective in use cases as described below, for example.

As an example, the information processing method according to the present embodiment is applicable to the refinement of risk scenario analysis.

In general risk scenario analysis, a current portfolio is treated fixedly, and a loss when a market risk occurs is estimated.

On the other hand, in the information processing method according to the present embodiment, it is assumed that the portfolio dynamically varies according to the market situation. On this assumption, it is possible to more precisely estimate the loss in consideration of the investment action as a reaction of the fund (subject) to the market risk and the like.

Furthermore, by the information processing method according to the present embodiment, it is possible to predict the investment action according to characteristics of each of all entrusted investment institutions (task executors) with respect to any market change, and assume which fund can take similar action, or the like. In this manner, it is possible to quantitatively evaluate the possibility that a previously-expected manager structure (the configuration of an investment institution employed as an entrusted entity) varies.

Furthermore, as an example, the information processing method according to the present embodiment is applicable to, for example, selection of an investment institution.

For example, in a case where a certain institution attempts to employ a new investment institution, there is limited information on candidate investment institutions available to the institution as compared to contracted investment institutions.

On the other hand, by the information processing method according to the present embodiment, it is possible to predict action in various market environments in advance by learning investment actions by the candidate investment institutions. In this manner, it is possible to construct a new highly effective manager structure.

Furthermore, as an example, the information processing method according to the present embodiment can be applied to assisting a dialogue with a fund.

In general, asset managers and the like in funds have high expertise in investment. Here, in a case where a person in charge at an institution does not have specialized knowledge equivalent to that of an asset manager, the person in charge may not be able to make an argument against a proposal of the asset manager, and there may be a situation where the person in charge has no choice but to accept the proposal.

However, by the information processing method according to the present embodiment, it is possible to predict the investment action by the subject in advance. In this manner, the person in charge at the institution can grasp a change in style related to the investment action, abnormal trade, and the like by comparing the prediction with records, and can have a dialogue at the same level as the asset manager.

Furthermore, as an example, the information processing method according to the present embodiment can be applied to duplication of a fund.

As described above, by the information processing method according to the present embodiment, the investment action can be modeled on the basis of a past record of the investment action by a fund selected as the subject. In this manner, by incorporating the investment action predicted by the model into in-house operation, it is possible to introduce an advanced strategy of the subject at low cost.

<<1.2. System Configuration Example>>

Next, a system configuration example according to the present embodiment will be described in detail. The system according to the present embodiment includes a learning device 10 that performs manifold learning using a machine learning algorithm and the prediction device 20 that performs prediction using a classifier generated by the manifold learning by the learning device 10.

(Learning Device 10)

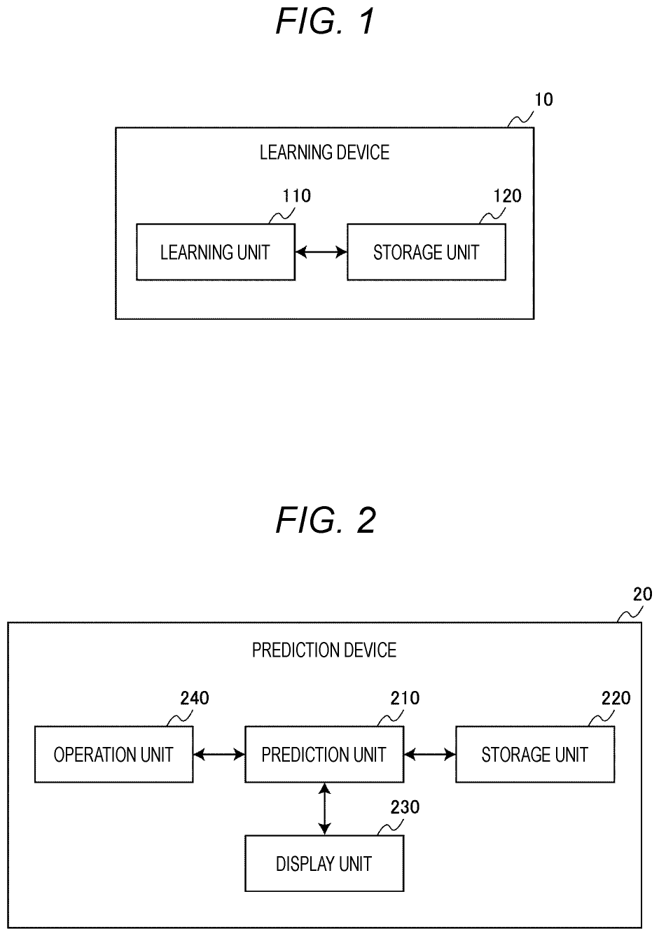

First, a functional configuration example of the learning device 10 according to the present embodiment will be described. FIG. 1 is a block diagram illustrating the functional configuration example of the learning device 10 according to the present embodiment.

As illustrated in FIG. 1, the learning device 10 according to the present embodiment may include a learning unit 110 and a storage unit 120.

(Learning Unit 110)

The learning unit 110 according to the present embodiment performs the manifold learning using the machine learning algorithm.

For example, the learning unit 110 according to the present embodiment learns the classification related to the preference record data on the basis of the preference record data indicating a record of the preference action related to a predetermined task executed by the subject.

The preference record data according to the present embodiment may include situation transition data indicating a transition of a past situation and past preference ratio data indicating a preference ratio of a preference target that has been a target of the preference action in the past situation.

As described above, the preference action may be an investment action of selecting a financial product (for example, a name) to be invested or an investment amount from among a plurality of financial products.

In this case, the preference record data according to the present embodiment can be said to be investment record data indicating a record of the investment action performed by the subject.

Furthermore, in this case, the situation transition data included in the preference record data may be data indicating a transition of a past market environment.

Note that examples of the situation transition data described above include a factor return and a factor property.

As the factor return, a market return, a return difference between value and growth, a return difference between small and large, a momentum, or the like may be employed.

In addition, as the factor property, an excess return against benchmark, an aggregate market value, a price book-value ratio (PBR), or the like may be employed.

Furthermore, the past preference ratio data included in the preference record data can be record information of the active weight in the past indicating an investment ratio of a name that can be a target of an investment action.

The learning unit 110 according to the present embodiment may input the preference record data as described above to a neural network and perform the manifold learning for classifying a name into a plurality of units (best matching units (BMUs)).

An example of the manifold learning described above includes a self-organizing maps (SOM).

The function of the learning unit 110 according to the present embodiment is achieved by a processor such as a GPU.

(Storage Unit 120)

The storage unit 120 according to the present embodiment stores various types of information regarding the manifold learning executed by the learning unit 110. For example, the storage unit 120 stores a structure of a network used for the manifold learning by the learning unit 110, various parameters related to the network, learning data, and the like.

The functional configuration example of the learning device 10 according to the present embodiment has been described above. Note that the functional configuration described above with reference to FIG. 1 is merely an example, and the functional configuration of the learning device 10 according to the present embodiment is not limited to such an example.

For example, the learning device 10 according to the present embodiment may further include an operation unit that receives an operation by the user, a display unit that displays various types of information, and the like.

The functional configuration of the learning device 10 according to the present embodiment can be flexibly modified according to specifications and operations.

(Prediction Device 20)

Next, a functional configuration example of the prediction device 20 according to the present embodiment will be described. The prediction device 20 according to the present embodiment is an example of an information processing device that performs prediction using a classifier generated by the manifold learning by the learning device 10.

FIG. 2 is a block diagram illustrating a functional configuration example of the prediction device 20 according to the present embodiment. As illustrated in FIG. 2, the prediction device 20 according to the present embodiment may include the prediction unit 210, a storage unit 220, a display unit 230, and an operation unit 240.

(Prediction Unit 210)

The prediction unit 210 according to the present embodiment outputs the preference prediction data indicating prediction of the preference action that is possible to be executed by the subject in a predetermined situation on the basis of the preference record data indicating the record of the preference action related to the predetermined task executed by the subject.

Furthermore, one of the features of the prediction unit 210 according to the present embodiment is to input the preference record data to a classifier generated by the manifold learning by the learning device 10, and to output the preference prediction data on the basis of applying a prediction model based on assumed information related to the predetermined situation for each of a plurality of classified units.

As described above, the classifier generated by the manifold learning by the learning device 10 may be a self-organizing map.

The prediction unit 210 according to the present embodiment accurately predicts an action that is possible to be executed by the subject task in a predetermined situation.

Details of the functions of the prediction unit 210 according to the present embodiment will be separately described. Note that the function of the prediction unit 210 according to the present embodiment is achieved by a processor such as a GPU.

(Storage Unit 220)

The storage unit 220 according to the present embodiment stores various types of information used by the prediction device 20. The storage unit 220 stores, for example, the preference record data, the structure and parameters of the classifier used by the prediction unit 210, the preference prediction data output by the prediction unit 210, and the like.

(Display Unit 230)

The display unit 230 according to the present embodiment displays various types of visual information. For this purpose, the display unit 230 according to the present embodiment includes a display.

For example, the display unit 230 according to the present embodiment displays a result of prediction by the prediction unit 210 in accordance with control by the prediction unit 210. The result of the prediction includes various maps generated by the prediction unit 210.

(Operation Unit 240)

The operation unit 240 according to the present embodiment receives an operation by a user. For this purpose, the operation unit 240 according to the present embodiment includes various input devices such as a keyboard and a mouse.

The functional configuration of the prediction device 20 according to the present embodiment has been described above. Note that the functional configuration described above with reference to FIG. 2 is merely an example, and the functional configuration of the prediction device 20 according to the present embodiment is not limited to such an example.

For example, the prediction unit 210 and the storage unit 220 according to the present embodiment, and the display unit 230 and the operation unit 240 may be provided in separate devices. For example, the prediction unit 210 and the storage unit 220 may be included in an information processing device arranged on a cloud, and the display unit 230 and the operation unit 240 may be included in an information processing device arranged locally.

The functional configuration of the prediction device 20 according to the present embodiment can be flexibly modified according to specifications and operations.

<<1.3. Details of Prediction>>

Next, prediction by the prediction unit 210 according to the present embodiment will be described in detail.

As described above, the prediction unit 210 according to the present embodiment outputs the preference prediction data indicating the prediction of the preference action that is possible to be executed by the subject in the predetermined situation on the basis of the preference record data indicating the record of the preference action related to the predetermined task executed by the subject.

Hereinafter, a case where the predetermined task described above is asset management and the preference action is an investment action for a financial product will be described.

In this case, the preference record data according to the present embodiment may be investment record data indicating a record of an investment action executed by the subject.

In addition, the situation transition data included in the preference record data may be data indicating a transition of a past market environment.

Furthermore, the past preference ratio data included in the preference record data may be record information of the active weight in the past indicating an investment ratio of a name that can be a target of an investment action.

The prediction unit 210 according to the present embodiment can classify a plurality of preference targets, that is, a plurality of names, into a plurality of prescribed BMUs (hereinafter, it may be simply referred to as a unit) by inputting the preference record data as described above to the self-organizing map.

In addition, at this time, the prediction unit 210 according to the present embodiment may generate a map in which, for each of the units, intensity of an index based on a preference ratio of a name belonging to the unit is expressed in a form of a heat map.

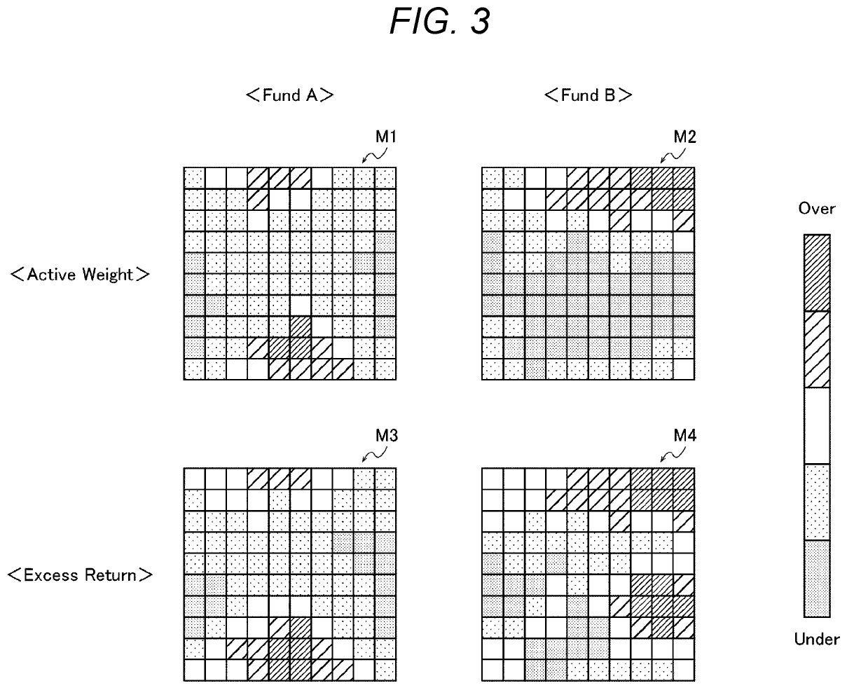

FIG. 3 is a diagram for describing classification of a preference target using the self-organizing map by the prediction unit 210 according to the present embodiment and generation of a map in which intensity of an index based on a preference ratio of a classified preference target is expressed in the form of a heat map.

For example, on the left side of FIG. 3, a map M1 and a map M3 generated by the prediction unit 210 on the basis of the preference record data related to the fund A as the subject are illustrated. Furthermore, on the right side of FIG. 3, a map M2 and a map M4 generated by the prediction unit 210 on the basis of the preference record data related to the fund B as the subject are illustrated.

Here, the preference record data related to the fund A and the preference record data related to the fund B are acquired completely in the same period, and the situation transition data included in both the preference record data may be the same.

In this case, names as preference targets can be classified into the same unit in the maps M1 to M4.

On the other hand, the past preference ratio data included in the preference record data related to the fund A (the record information of the active weight in the past) and the past preference ratio data included in the preference record data related to the fund B are different from each other.

For this reason, as illustrated in the upper part of FIG. 3, the prediction unit 210 may generate the map M1 and the map M2 in which intensity of the preference ratio of a name classified into each of the units is expressed in the form of a heat map on the basis of the record information of the active weight in the past.

In addition, as illustrated in the lower part of FIG. 3, the prediction unit 210 may generate the map M3 and the map M4 in which intensity of the excess return against benchmark of a name classified into each of the units is expressed in the form of a heat map on the basis of the record information of the active weight in the past and the excess return against benchmark for each name.

Note that, in the example illustrated in FIG. 3, the intensity of each index is expressed using dots and oblique lines. Specifically, it is expressed that the intensity is low in a case where the unit is expressed by dots, and the degree of intensity is lower as the density of dots is higher. On the other hand, it is expressed that the intensity is high in a case where the unit is expressed by oblique lines, and the degree of intensity is higher as the density of oblique lines is higher.

Comparing the map M1 and the map M2, for example, it can be grasped that the fund A holds more names classified into units positioned on a lower side of the center of the map than a market average, whereas the fund B holds more names classified into units positioned on a right side of the map than the market average.

Furthermore, when comparing the map M1 and the map M3, it can be grasped that the fund A obtains a profit higher than the market average for the name of interest by holding more names classified as units positioned below the center of the map than the market average.

On the other hand, when comparing the map M2 and the map M4, it can be grasped that the fund B obtains a profit higher than the market average for the name of interest by holding more names classified as units positioned on the right side of the map than the market average.

Furthermore, when comparing the map M2 and the map M4, it can be grasped that the fund B obtains a profit higher than the market average for the name of interest by holding less names classified as units positioned slightly below the center on the right side of the map than the market average.

As described above, by the prediction unit 210 according to the present embodiment, it is possible to analyze the difference and similarity of the investment action by each fund by performing the heat mapping based on the classification using the self-organizing map and an attribute of each name.

Furthermore, the prediction unit 210 according to the present embodiment can output the preference prediction data by applying the prediction model based on the assumed information related to an assumed predetermined situation for each of the units.

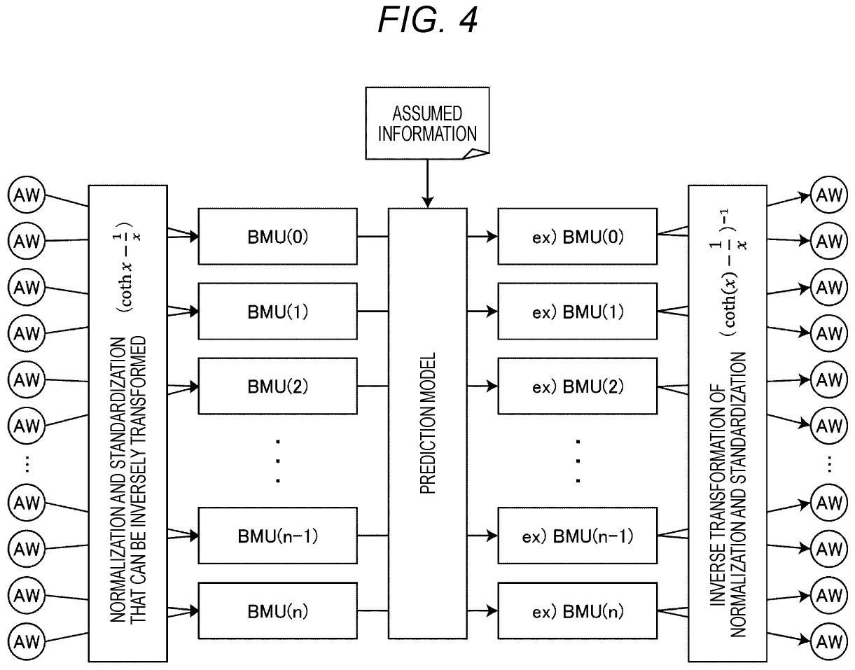

FIG. 4 is a schematic diagram for describing the output of the preference prediction data by the prediction unit 210 according to the present embodiment.

As described above, the preference record data input to the self-organizing map according to the present embodiment includes the past preference ratio data indicating the preference ratio of a preference target that has been possible to become the target of the preference action in the past situation.

In a case where the preference record data is the investment record data by the subject, the past preference ratio data described above may be the record information of the active weight in the past.

In this case, the prediction unit 210 according to the present embodiment classifies a plurality of names that is possible to become the preference target, that is, the investment target, into a plurality of BMUs by inputting the preference record data to the self-organizing map, and acquires a first codebook vector for each of the BMUs.

At this time, in the self-organizing map according to the present embodiment, normalization and standardization processing that can be inversely transformed is performed on the preference record data including the record information of the active weight described above, and each name is classified into a plurality of units.

Here, the first codebook vector described above can be said to be a variable corresponding to a preference ratio (investment ratio) of a name to be classified into each BMU obtained for each of the BMUs (0 to n).

Next, the prediction unit 210 according to the present embodiment acquires a second codebook vector for each of the BMUs by applying the prediction model based on the assumed information related to an assumed predetermined situation to the first codebook vector acquired for each of the BMUs.

Here, the second codebook vector described above can be said to be a variable corresponding to a predicted preference ratio (predicted investment ratio) in a predetermined situation of a name to be classified into each BMU obtained for each of the BMUs (0 to n).

Note that the assumed information described above may include at least one of assumed information of a factor return or assumed information of a factor property in the predetermined situation assumed by an analyst.

For example, the assumed information of the factor return includes assumed information of a market return, a return difference between value and growth, a return difference between small and large, or momentum in the assumed predetermined situation.

On the other hand, the assumed information of the factor property includes an excess return against benchmark, an aggregate market value, a price book-value ratio, or the like in the assumed predetermined situation.

The analyst may assume an arbitrary situation in which the preference action by the subject is desired to be predicted and set the assumed information related to the situation.

The predetermined situation described above may be, for example, a market environment after several months or one year in a case where there is no major change, a market environment after several months or one year in a case where rapid yen appreciation progresses, or the like.

Furthermore, examples of the prediction model based on the assumed information as described above include a multiple regression model, a vector autoregressive model, a graphical neural network (GNN) type, or the like.

The prediction model according to the present embodiment can be appropriately set on the basis of a tendency of the preference action by the subject, and the like.

For example, the multiple regression model may be used for prediction of the preference action by the subject of a discretionary type having a relatively low trade frequency.

Here, in a case where the factor return in an assumed predetermined situation (t) is represented by the following Expression (1), a second codebook vector CV obtained by the multiple regression model is represented by, for example, the following Expression (2). Note that B in Expression (2) is a regression coefficient for each factor return estimated from the past FR and CV.

[Math. 1]

FRₜ={f₁,f₂, . . . fₙ} (1)

CV_{i,t}=FRₜ×B (2)

On the other hand, for example, the vector autoregressive model may be used for prediction of the preference action by the subject of a Quants type having a relatively high trade frequency or the subject of a type that greatly changes the style.

The second codebook vector CV obtained by the vector autoregressive model is represented by, for example, the following Expression (3). Note that B⁽ⁱ⁾ in Expression (3) indicates a vector corresponding to the i-th BMU among regression coefficients B estimated as described above, and B t is expressed by the following Expression (4). Note that F and Q in Expression (4) are matrices representing features each estimated from a past CV transition in a case where the entire analytical fund is regarded as one system.

[Math. 2]

CV_{i,t}=FRₜ×Bₜ⁽ⁱ⁾ (3)

Bₜ=FBₜ₋₁+Q (4)

On the other hand, for example, the GNN model may be used in a case where prediction of preference actions by a plurality of types of subjects is simultaneously processed (for example, prediction of preference actions in units of manager structures).

Next, the prediction unit 210 according to the present embodiment outputs the preference prediction data by performing inverse transformation of normalization and standardization on the second codebook vector acquired for each of the BMUs by using the prediction model as described above.

The preference prediction data described above may include predicted preference ratio data indicating a predicted preference ratio of the preference target in the predetermined situation.

For example, in a case where the preference record data used for input to the self-organizing map is investment record data by the subject, the predicted preference ratio data may be prediction information of the active weight indicating a holding ratio of each name in the predetermined situation.

The output of predicted change ratio data by the prediction unit 210 according to the present embodiment has been described in detail above.

Note that the prediction unit 210 according to the present embodiment may generate a map in which intensity of the predicted preference ratio of the preference target is expressed in the form of a heat map in each of the BMUs on the basis of the predicted change ratio data output as described above.

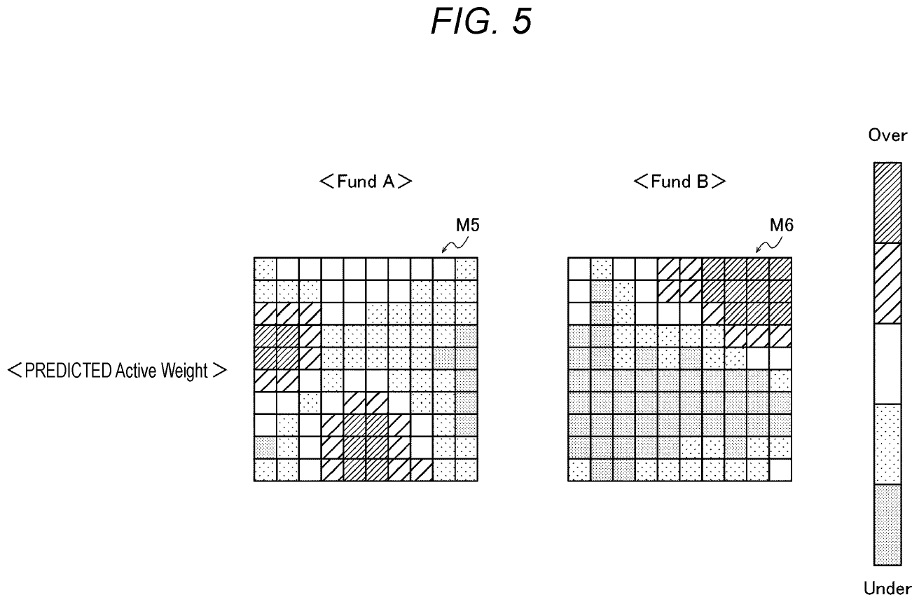

FIG. 5 is a diagram illustrating an example of a map in which intensity of the predicted preference ratio of the preference target is expressed in the form of a heat map, the map being generated by the prediction unit 210 according to the present embodiment.

On the left side of FIG. 5, a map M5 generated by the prediction unit 210 on the basis of the preference record data and the predicted preference ratio data regarding the fund A as the subject is illustrated. Furthermore, on the right side of FIG. 5, a map M6 generated by the prediction unit 210 on the basis of the preference record data and the predicted preference ratio data regarding the fund B as the subject is illustrated.

The prediction unit 210 according to the present embodiment can generate the map M5 or the map M6 in which intensity of a predicted holding ratio in the predetermined situation of each name classified into each of the BMUs is expressed in the form of a heat map on the basis of the output predicted change ratio data, that is, the prediction information of the active weight in the predetermined situation.

For example, the analyst can visually and intuitively grasp how the active weight related to the fund A changes in the predetermined situation by comparing the map M1 illustrated in FIG. 3 with the map M5 illustrated in FIG. 5.

Similarly, the analyst can visually and intuitively grasp how the active weight related to the fund B changes in the predetermined situation by comparing the map M2 illustrated in FIG. 3 with the map M6 illustrated in FIG. 5.

For the comparison as described above, the prediction unit 210 according to the present embodiment may control the display unit 230 to display the map M1 and the map M5, and the map M2 and the map M6 side by side.

On the other hand, the prediction unit 210 according to the present embodiment may generate a map in which magnitude of a difference between the predicted preference ratio data and the past preference ratio data is expressed in the form of a heat map in each of the BMUs, and display the map on the display unit 230.

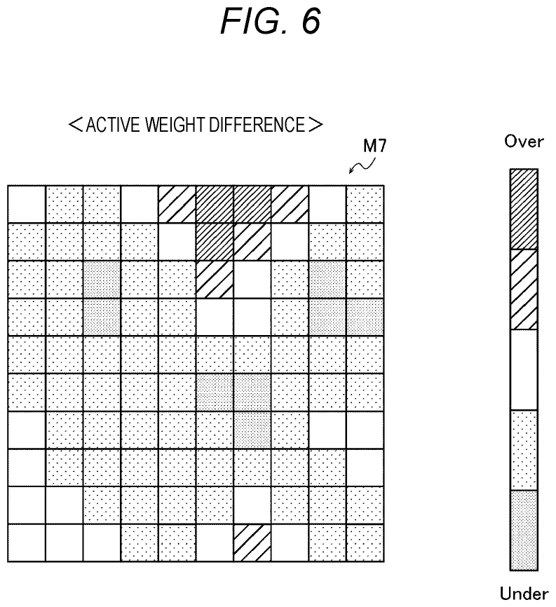

For example, as illustrated in FIG. 6, the prediction unit 210 according to the present embodiment may generate a map M7 in which the magnitude of the difference between the prediction information of the active weight in the predetermined situation and the record information of the active weight in the past is expressed in the form of a heat map in each of the BMUs.

In the map M7, the magnitude of the difference between the prediction information of the active weight in the predetermined situation and the record information of the active weight in the past is expressed using dots and oblique lines. Specifically, it is expressed that the difference described above is small in a case where the BMU is expressed by dots, and the difference described above is smaller as the density of dots is higher. On the other hand, it is expressed that the difference described above is large in a case where the BMU is expressed by oblique lines, and the difference described above is larger as the density of oblique lines is higher.

According to the map as described above, the analyst can more intuitively grasp how the active weight related to the subject changes in the predetermined situation.

Furthermore, FIGS. 5 and 6 illustrate a case where the prediction unit 210 outputs the preference prediction data related to a single subject and performs map generation based on the preference prediction data.

On the other hand, the prediction unit 210 according to the present embodiment may output the preference prediction data indicating the prediction of the preference action that is possible to be executed by the plurality of subjects in the predetermined situation on the basis of the plurality of pieces of preference record data related to the plurality of subjects.

That is, the prediction unit 210 according to the present embodiment can predict the preference action in units of manager structures.

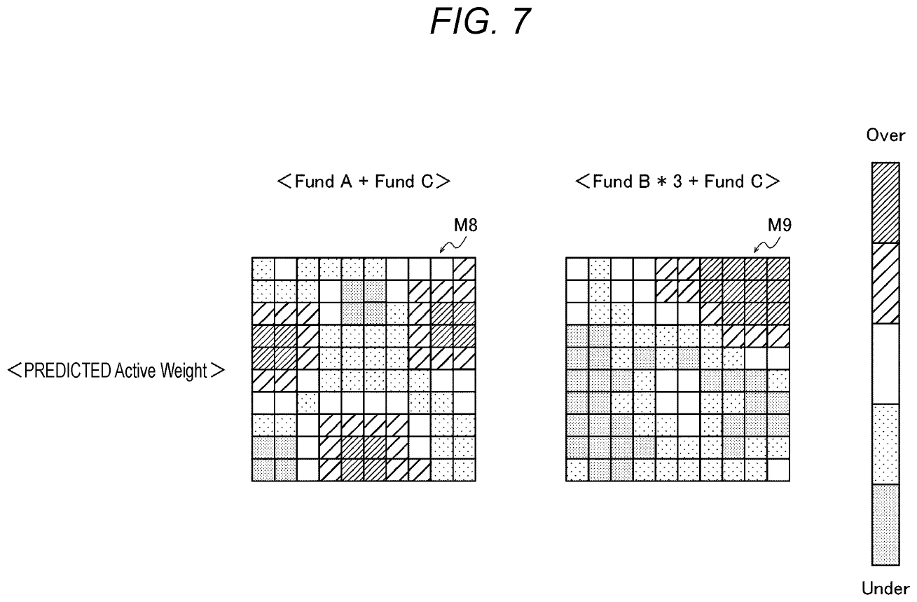

FIG. 7 is a diagram illustrating an example of a map based on preference prediction data indicating prediction of a preference action that is possible to be executed by a plurality of subjects according to the present embodiment.

For example, a map M8 illustrated in FIG. 7 is an example of a map generated by the prediction unit 210 on the basis of the preference prediction data obtained by inputting, to the self-organizing map, data obtained by merging the preference record data related to the fund A and the preference record data related to the fund C at 1:1.

According to the map M8 as described above, in a case where the same assets are distributed to the fund A and the fund C, the analyst can visually and intuitively grasp what type of active weight is formed in the predetermined situation.

On the other hand, a map M9 illustrated in FIG. 7 is an example of a map generated by the prediction unit 210 on the basis of the preference prediction data obtained by inputting, to the self-organizing map, data obtained by merging the preference record data related to the fund B and the preference record data related to the fund C at 3:1.

According to the map M9 as described above, in a case where the fund B and the fund C are employed and assets three times as large as the fund C are distributed to the fund B, the analyst can visually and intuitively grasp what active weight is formed in the predetermined situation.

As described above, by the prediction unit 210 according to the present embodiment, it is possible to accurately predict an action that is possible to be executed by a single or a plurality of subjects in the predetermined situation and visualize the prediction result.

<<1.4. Flow of Prediction>>

Next, a flow of prediction of the preference action by the prediction unit 210 according to the present embodiment will be described in detail with an example.

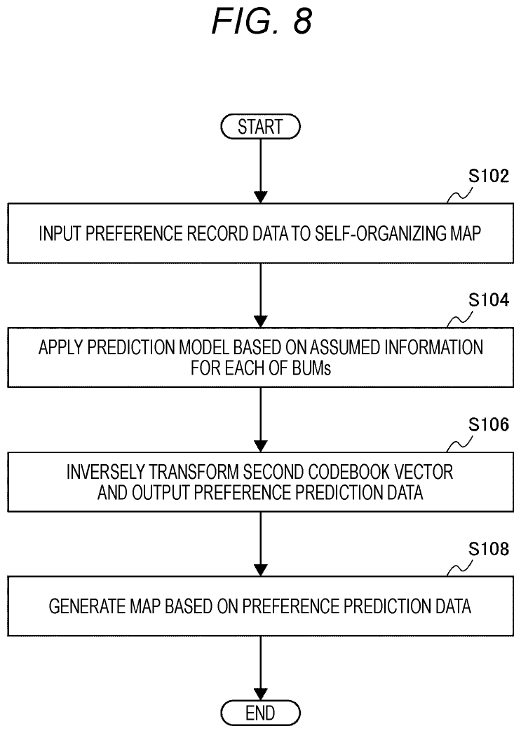

FIG. 8 is a flowchart illustrating an example of a flow of prediction of the preference action by the prediction unit 210 according to the present embodiment.

In a case of the example illustrated in FIG. 8, the prediction unit 210 first inputs the preference record data to the self-organizing map (S102).

Next, the prediction unit 210 acquires the second codebook vector by applying the prediction model based on the assumed information for each of the BMUs (S104).

Next, the prediction unit 210 performs the inverse transformation of the normalization and the standardization on the second codebook vector acquired in step S104, and outputs the preference prediction data (S106).

Next, the prediction unit 210 generates various maps on the basis of the preference prediction data output in step S106 (S108).

### 2. Hardware Configuration Example

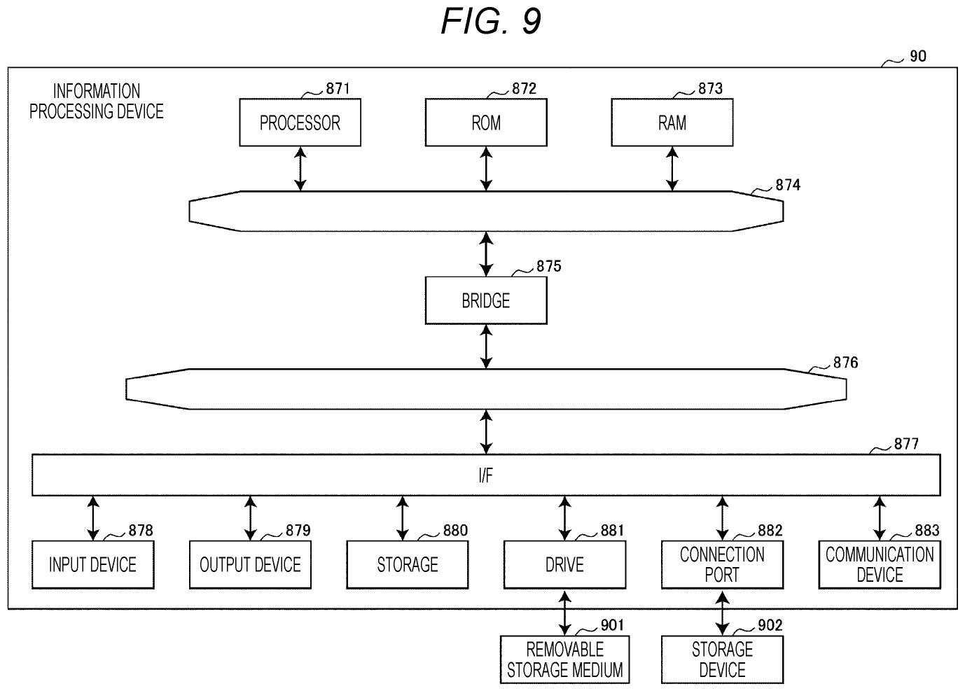

Next, a hardware configuration example common to the learning device 10 and the prediction device 20 according to one embodiment of the present disclosure will be described. FIG. 9 is a block diagram illustrating a hardware configuration example of an information processing device 90 according to the one embodiment of the present disclosure. The information processing device 90 may be a device having a hardware configuration equivalent to that of each of the above-described devices.

As illustrated in FIG. 9, the information processing device 90 includes, for example, a processor 871, a ROM 872, a RAM 873, a host bus 874, a bridge 875, an external bus 876, an interface 877, an input device 878, an output device 879, a storage 880, a drive 881, a connection port 882, and a communication device 883. Note that the hardware configuration illustrated here is an example, and some of the components may be omitted. In addition, components other than the components illustrated here may be further included.

(Processor 871)

The processor 871 functions as, for example, an arithmetic processing device or a control device, and controls the overall operation of each component or a part thereof on the basis of various programs recorded in the ROM 872, the RAM 873, the storage 880, or a removable storage medium 901.

(ROM872, RAM873)

The ROM 872 is a unit that stores a program read by the processor 871, data used for calculation, and the like. The RAM 873 temporarily or permanently stores, for example, a program read by the processor 871, various parameters that appropriately change when the program is executed, and the like.

(Host Bus 874, Bridge 875, External Bus 876, and Interface 877)

The processor 871, the ROM 872, and the RAM 873 are mutually connected via, for example, the host bus 874 capable of high-speed data transmission. On the other hand, the host bus 874 is connected to the external bus 876 having a relatively low data transmission speed via the bridge 875, for example. Furthermore, the external bus 876 is connected to various components via the interface 877.

(Input Device 878)

As the input device 878, for example, a mouse, a keyboard, a touch panel, a button, a switch, a lever, and the like are used. Moreover, as the input device 878, a remote controller (hereinafter, remote controller) capable of transmitting a control signal using infrared rays or other radio waves may be used. Furthermore, the input device 878 includes a voice input device such as a microphone.

(Output Device 879)

The output device 879 is a device capable of visually or audibly notifying the user of acquired information, such as a display device such as a cathode ray tube (CRT), an LCD, or an organic EL, an audio output device such as a speaker or a headphone, a printer, a mobile phone, or a facsimile, for example. Furthermore, the output device 879 according to the present disclosure includes various vibration devices capable of outputting tactile stimulation.

(Storage 880)

The storage 880 is a device for storing various data. As the storage 880, for example, a magnetic storage device such as a hard disk drive (HDD), a semiconductor storage device, an optical storage device, a magneto-optical storage device, or the like is used.

(Drive 881)

The drive 881 is, for example, a device that reads information recorded on the removable storage medium 901 such as a magnetic disk, an optical disk, a magneto-optical disk, or a semiconductor memory, or writes information on the removable storage medium 901.

(Removable Storage Medium 901)

The removable storage medium 901 is, for example, a DVD medium, a Blu-ray (registered trademark) medium, an HD DVD medium, various semiconductor storage media, or the like. Of course, the removable storage medium 901 may be, for example, an IC card on which a non-contact IC chip is mounted, an electronic device, or the like.

(Connection Port 882)

The connection port 882 is a port for connecting an external connection device 902 such as a universal serial bus (USB) port, an IEEE 1394 port, a small computer system interface (SCSI), an RS-232C port, or an optical audio terminal, for example.

(External Connection Device 902)

The external connection device 902 is, for example, a printer, a portable music player, a digital camera, a digital video camera, an IC recorder, or the like.

(Communication Device 883)

The communication device 883 is a communication device for connecting to a network, and is, for example, a communication card for wired or wireless LAN, Bluetooth (registered trademark), or wireless USB (WUSB), a router for optical communication, a router for Asymmetric Digital Subscriber Line (ADSL), or a modem for various communications, or the like.

### 3. Summary

As described above, the prediction unit 210 according to one embodiment of the present disclosure outputs the preference prediction data indicating the prediction of the preference action that is possible to be executed by the subject in the predetermined situation on the basis of the preference record data indicating the record of the preference action related to the predetermined task executed by the subject.

Furthermore, one of the features of the prediction unit 210 according to the one embodiment of the present disclosure is to input the preference record data to a classifier generated by the manifold learning by the learning device 10, and to output the preference prediction data on the basis of applying a prediction model based on assumed information related to the predetermined situation for each of a plurality of classified units.

According to the configuration described above, it is possible to accurately predict an action that is possible to be executed by the subject in a predetermined situation.

The preferred embodiments of the present disclosure have been described above in detail with reference to the accompanying drawings, but the technical scope of the present disclosure is not limited to such examples. It is apparent that a person having ordinary knowledge in the technical field of the present disclosure can devise various change examples or modification examples within the scope of the technical idea described in the claims, and it will be naturally understood that they also belong to the technical scope of the present disclosure.

For example, in the embodiments described above, the case where the predetermined task is asset management and the preference action of the subject is an investment action has been described as a main example. However, the predetermined task and the preference action are not limited to such examples.

For example, the predetermined task may be product sales expansion, and the preference action may be selecting a medium to deploy marketing and distributing the budget to each medium. In addition, for example, the predetermined task may be acquisition of a contract, and the preference action may be distribution of time allocated to various business activities (for example, visit, telephone, e-mail, presentation, and the like).

Even in a case as described above, according to the configuration as described above, it is possible to accurately predict an action that is possible to be executed by the subject in a predetermined situation.

Furthermore, each step related to the processing described in the present description is not necessarily processed in time series in the order described in the flowchart or the sequence diagram. For example, each step related to the processing of each device may be processed in an order different from the described order or may be processed in parallel.

In addition, the series of processes performed by each device described in the present description may be achieved using any of software, hardware, and a combination of software and hardware. The program constituting the software is provided inside or outside each device, for example, and is stored in advance in a non-transitory computer readable medium readable by a computer. Then, each program is read into the RAM at the time of execution by the computer, for example, and is executed by various processors. The storage medium described above is, for example, a magnetic disk, an optical disk, a magneto-optical disk, a flash memory, or the like. In addition, the computer program described above may be distributed via, for example, a network without using a storage medium.

Furthermore, the effects described in the present description are merely illustrative or exemplary and are not limited. That is, the technology according to the present disclosure can exhibit other effects that are apparent to those skilled in the art from the present description in addition to or instead of the effects described above.

Note that configurations as follows also belong to the technical scope of the present disclosure.

(1)

An information processing device, including
a prediction unit that outputs preference prediction data indicating prediction of a preference action that is possible to be executed by a subject in a predetermined situation on the basis of preference record data indicating a record of the preference action related to a predetermined task executed by the subject, in which
the prediction unit inputs the preference record data to a classifier generated by manifold learning, and outputs the preference prediction data on the basis of applying a prediction model based on assumed information related to the predetermined situation for each of a plurality of classified units.

(2)

The information processing device according to (1) above, in which the classifier generated by the manifold learning includes a self-organizing map.

(3)

The information processing device according to (2) above, in which
the preference record data includes situation transition data indicating a transition of a past situation and past preference ratio data indicating a preference ratio of a preference target that has been possible to become a target of the preference action in the past situation, and
the prediction unit classifies the preference target into a plurality of the units by inputting the preference record data to the self-organizing map, and acquires a first codebook vector for each of the units.

(4)

The information processing device according to (3) above, in which the prediction unit acquires a second codebook vector for each of the units by applying the prediction model based on the assumed information related to the predetermined situation to the first codebook vector acquired for each of the units.

(5)

The information processing device according to (4) above, in which the prediction unit outputs the preference prediction data by performing inverse transformation processing on the second codebook vector acquired for each of the units.

(6)

The information processing device according to (5) above, in which the preference prediction data includes predicted preference ratio data indicating a predicted preference ratio of the preference target in the predetermined situation.

(7)

The information processing device according to (6) above, in which the prediction unit generates a map in which intensity of a predicted preference ratio of the preference target is expressed in a form of a heat map in each of the units on the basis of the predicted preference ratio data.

(8)

The information processing device according to (6) or (7) above, in which the prediction unit generates a map in which magnitude of a difference between the predicted preference ratio data and the past preference ratio data is expressed in a form of a heat map in each of the units.

(9)

The information processing device according to any one of (1) to (8) above, in which the prediction unit outputs, on the basis of a plurality of pieces of the preference record data related to a plurality of the subjects, preference prediction data indicating prediction of the preference action that is possible to be executed by the plurality of the subjects in a predetermined situation.

(10)

The information processing device according to any one of (1) to (9) above, in which
the predetermined task includes asset management, and
the preference action includes an investment action in a financial product.

(11)

The information processing device according to any one of (1) to (10) above, in which
the preference record data includes record information of an active weight in a past, and
the preference prediction data includes prediction information of the active weight in the predetermined situation.

(12)

The information processing device according to (10) or (11) above, in which the assumed information includes at least one of assumed information of a factor return or assumed information of a factor property in the predetermined situation.

(13)

The information processing device according to (12) above, in which the assumed information of the factor return includes assumed information related to at least one of a market return, a return difference between value and growth, a return difference between small and large, or momentum.

(14)

The information processing device according to (12) or (13) above, in which the assumed information of the factor property includes assumed information related to at least one of an excess return against benchmark, an aggregate market value, or a price book-value ratio.

(15)

The information processing device according to any one of (1) to (14) above, in which the prediction model includes any one of a multiple regression model, a vector autoregressive model, or a graphical neural network (GNN) model.

(16)

The information processing device according to (6) or (7) above, further including
a display unit that displays a map generated by the prediction unit.

(17)

An information processing method, including
outputting, by a processor, preference prediction data indicating prediction of a preference action that is possible to be executed by a subject in a predetermined situation on the basis of preference record data indicating a record of the preference action related to a predetermined task executed by the subject, in which
the outputting includes inputting the preference record data to a classifier generated by manifold learning, and outputting the preference prediction data on the basis of applying a prediction model based on assumed information related to the predetermined situation for each of a plurality of classified units.

(18)

A program for causing a computer to function as an information processing device, in which
the information processing device includes a prediction unit that outputs preference prediction data indicating prediction of a preference action that is possible to be executed by a subject in a predetermined situation on the basis of preference record data indicating a record of the preference action related to a predetermined task executed by the subject, and
the prediction unit inputs the preference record data to a classifier generated by manifold learning, and outputs the preference prediction data on the basis of applying a prediction model based on assumed information related to the predetermined situation for each of a plurality of units classified.

### REFERENCE SIGNS LIST

10 Learning device
110 Learning unit
120 Storage unit
20 Prediction device
210 Prediction unit
220 Storage unit
230 Display unit
240 Operation unit

1. An information processing device, comprising
a prediction unit that outputs preference prediction data indicating prediction of a preference action that is possible to be executed by a subject in a predetermined situation on a basis of preference record data indicating a record of the preference action related to a predetermined task executed by the subject, wherein
the prediction unit inputs the preference record data to a classifier generated by manifold learning, and outputs the preference prediction data on a basis of applying a prediction model based on assumed information related to the predetermined situation for each of a plurality of classified units.

2. The information processing device according to claim 1, wherein the classifier generated by the manifold learning includes a self-organizing map.

3. The information processing device according to claim 2, wherein
the preference record data includes situation transition data indicating a transition of a past situation and past preference ratio data indicating a preference ratio of a preference target that has been possible to become a target of the preference action in the past situation, and
the prediction unit classifies the preference target into a plurality of the units by inputting the preference record data to the self-organizing map, and acquires a first codebook vector for each of the units.

4. The information processing device according to claim 3, wherein the prediction unit acquires a second codebook vector for each of the units by applying the prediction model based on the assumed information related to the predetermined situation to the first codebook vector acquired for each of the units.

5. The information processing device according to claim 4, wherein the prediction unit outputs the preference prediction data by performing inverse transformation processing on the second codebook vector acquired for each of the units.

6. The information processing device according to claim 5, wherein the preference prediction data includes predicted preference ratio data indicating a predicted preference ratio of the preference target in the predetermined situation.

7. The information processing device according to claim 6, wherein the prediction unit generates a map in which intensity of a predicted preference ratio of the preference target is expressed in a form of a heat map in each of the units on a basis of the predicted preference ratio data.

8. The information processing device according to claim 6, wherein the prediction unit generates a map in which magnitude of a difference between the predicted preference ratio data and the past preference ratio data is expressed in a form of a heat map in each of the units.

9. The information processing device according to claim 1, wherein the prediction unit outputs, on a basis of a plurality of pieces of the preference record data related to a plurality of the subjects, preference prediction data indicating prediction of the preference action that is possible to be executed by the plurality of the subjects in a predetermined situation.

10. The information processing device according to claim 1, wherein
the predetermined task includes asset management, and
the preference action includes an investment action in a financial product.

11. The information processing device according to claim 1, wherein
the preference record data includes record information of an active weight in a past, and
the preference prediction data includes prediction information of the active weight in the predetermined situation.

12. The information processing device according to claim 10, wherein the assumed information includes at least one of assumed information of a factor return or assumed information of a factor property in the predetermined situation.

13. The information processing device according to claim 12, wherein the assumed information of the factor return includes assumed information related to at least one of a market return, a return difference between value and growth, a return difference between small and large, or momentum.

14. The information processing device according to claim 12, wherein the assumed information of the factor property includes assumed information related to at least one of an excess return against benchmark, an aggregate market value, or a price book-value ratio.

15. The information processing device according to claim 1, wherein the prediction model includes any one of a multiple regression model, a vector autoregressive model, or a graphical neural network (GNN) model.

16. The information processing device according to claim 6, further comprising
a display unit that displays a map generated by the prediction unit.

17. An information processing method, comprising
outputting, by a processor, preference prediction data indicating prediction of a preference action that is possible to be executed by a subject in a predetermined situation on a basis of preference record data indicating a record of the preference action related to a predetermined task executed by the subject, wherein
the outputting includes inputting the preference record data to a classifier generated by manifold learning, and outputting the preference prediction data on a basis of applying a prediction model based on assumed information related to the predetermined situation for each of a plurality of classified units.

18. A program for causing a computer to function as an information processing device, wherein
the information processing device includes a prediction unit that outputs preference prediction data indicating prediction of a preference action that is possible to be executed by a subject in a predetermined situation on a basis of preference record data indicating a record of the preference action related to a predetermined task executed by the subject, and
the prediction unit inputs the preference record data to a classifier generated by manifold learning, and outputs the preference prediction data on a basis of applying a prediction model based on assumed information related to the predetermined situation for each of a plurality of units classified.
